(19) United States
(12) Patent Application Publication
(10) Pub. No.: US 2016/0198309 A1
(43) Pub. Date: Jul. 7, 2016

(54) APPARATUS AND METHOD FOR PROCESSING INDOOR GEOSPATIAL INFORMATION FOR INDOOR LOCATION-BASED SERVICES, AND USER TERMINAL

(71) Applicant: ELECTRONICS AND TELECOMMUNICATIONS RESEARCH INSTITUTE, Daejeon (KR)

(72) Inventors: Jae Jun YOO, Daejeon (KR); So Yeon LEE, Daejeon (KR); Sang Joon PARK, Daejeon (KR); Sung Woong SHIN, Daejeon (KR)

(21) Appl. No.: 14/988,095

(22) Filed: Jan. 5, 2016

(30) Foreign Application Priority Data
Jan. 5, 2015 (KR) 10-2015-0000836

(51) Int. Cl. H04W 4/04

(52) U.S. Cl. CPC H04W 4/043

(57) ABSTRACT

An apparatus for processing indoor geospatial information for an indoor location-based service and a method thereof are provided. The apparatus includes a registerer configured to classify and register indoor geospatial information according to conditions that include a structure of a building and features of indoor space, and provide a user terminal with access information regarding specific indoor geospatial information found by the user terminal; and a provider configured to provide indoor geospatial information to the user terminal that has accessed the provider using the access information regarding the indoor geospatial information.

### CROSS-REFERENCE TO RELATED APPLICATION(S)

This application claims priority from Korean Patent Application No. 10-2015-0000836, filed on Jan. 5, 2015, in the Korean Intellectual Property Office, the disclosure of which is incorporated herein by reference in its entirety.

### BACKGROUND

1. Field

The following description relates to a location-based service technology, and more specifically, to an indoor location-based service technology.

2. Description of the Related Art

With the increases in size and complexity of indoor space, activities taking place in outdoor space are moved to indoor space. For example, large convention centers and shopping malls have expanded their offerings, including not only business support and shopping, but also dining out, entertainment, and public transport facilities, such as subway and underground parking lot. As a result, services provided for outdoor spaces expand to indoor spaces.

Services provided for outdoor spaces are based on positions of user terminals and outdoor maps. For example, navigation services provided for outdoor spaces and web-based map services both are based on outdoor maps. To provide such outdoor-based services in indoor spaces, indoor location information of user terminals and various forms of indoor maps and information regarding the indoor space are essentially required.

Information, such as outdoor maps, road network information, etc. regarding outdoor spaces may be generally extracted from satellite images, and configured as a whole. However, due to various features of indoor spaces, indoor space information cannot be configured and utilized through the same method as used for outdoor space information. For example, the indoor spaces may have unique characteristic structures, address systems, ownerships, and personal information protection issues, which may be different from those of the outdoor spaces.

### SUMMARY

In one general aspect, there is provided an apparatus for processing indoor geospatial information for an indoor location-based service, the apparatus including: a registerer configured to classify and register indoor geospatial information according to conditions that include a structure of a building and features of indoor space, and provide a user terminal with access information regarding specific indoor geospatial information found by the user terminal; and a provider configured to provide indoor geospatial information to the user terminal that has accessed the provider using the access information regarding the indoor geospatial information.

The indoor geospatial information may include at least one of the following: an indoor map, information about region of interest (ROI), an indoor space model, indoor positioning reference information, indoor condition information, and indoor image information, or information extracted therefrom.

The features of indoor space may include at least one of the following: an address, a location, a floor number, a type of indoor geospatial information.

The registerer may register attribute information regarding the indoor geospatial information by taking into consideration the conditions that include a structure of a building and features of indoor space.

The attribute information regarding the indoor geospatial information may be cross-referenced, as well as registered as a package or a group into which the attribute information is classified according to the conditions that include a structure of a building and features of indoor space, so that the indoor geospatial information can be searched by the user terminal.

The attribute information regarding the indoor geospatial information may include at least one of the following: information needed to be provided for search for indoor geospatial information, metadata regarding indoor geospatial information, information about the provider that provides indoor geospatial information, information about an original provider of indoor geospatial information, information about a user who is allowed to use indoor geospatial information, security and charging information for utilizing indoor geospatial information, and information about a building and an indoor space based on which indoor geospatial information is configured.

The information needed to be provided for search for indoor geospatial information may include at least one of the following: a type of indoor geospatial information; a set of search keywords for indoor geospatial information; information about a building related to indoor geospatial information; a coordinate system which indoor geospatial information is based on; a geographical range related to indoor geospatial information and reference information therefor; a size and format of indoor geospatial information; version information of indoor geospatial information; validity period of registered indoor geospatial information; and next update of registered indoor geospatial information.

When the user terminal searches for desired indoor geospatial information, the registerer may receive at least one of the following: authentication information of a user terminal for access to the desired indoor geospatial information; information about a type of indoor geospatial information to be searched; and a search condition regarding indoor geospatial information, and provides the user terminal with the access information regarding the indoor geospatial information found based on the received information.

The apparatus may further include a collector configured to request the registerer to register attribute information regarding obtained indoor geospatial information, and deliver the obtained indoor geospatial information to the provider. The apparatus may further include an authenticator configured to authenticate a user terminal that is provided with an indoor location-based service.

In another general aspect, there is provided a user terminal including: a communicator configured to communicate with an apparatus for processing indoor geospatial information for an indoor location-based service, wherein the communicator receives access information regarding specific indoor geospatial information found from the apparatus, accesses the apparatus using the access information, and receives the specific indoor geospatial information from the apparatus, wherein the apparatus classifies and registers a variety of indoor geospatial information according to conditions that include a structure of a building and features of indoor space and the specific indoor geospatial information is found from the registered indoor geospatial information.

The communicator may request the apparatus to search for attribute information regarding the indoor geospatial information that has been registered by taking into consideration the conditions that include a structure of a building and features of indoor space. The attribute information regarding the indoor geospatial information may be cross-referenced, as well as registered as a package or a group into which the attribute information is classified according to the conditions that include a structure of a building and features of indoor space, so that the indoor geospatial information can be searched by the user terminal. The communicator may be authenticated by making a request to the apparatus for processing indoor geospatial information.

In yet another general aspect, there is provided a method for processing indoor geospatial information by an apparatus for processing indoor geospatial information, the method including: classifying and registering a variety of indoor geospatial information according to conditions that include a structure of a building and features of indoor space; providing a user terminal with access information regarding specific indoor geospatial information found by the user terminal; and providing the specific indoor geospatial information to the user terminal that has accessed the apparatus using the access information.

The indoor geospatial information may include at least one of the following: an indoor map, information about region of interest (ROI), an indoor space model, indoor positioning reference information, indoor condition information, and indoor image information, or information extracted therefrom.

In the registration of the indoor geospatial information, attribute information regarding the indoor geospatial information may be registered by taking into consideration the conditions that include a structure of a building and features of indoor space.

The attribute information regarding the indoor geospatial information may be cross-referenced, as well as registered as a package or a group into which the attribute information is classified according to the conditions that include a structure of a building and features of indoor space, so that the indoor geospatial information can be searched by the user terminal.

The attribute information regarding the indoor geospatial information may include at least one of the following: information needed to be provided for search for indoor geospatial information, metadata regarding indoor geospatial information, information about a provider that provides indoor geospatial information, information about an original provider of indoor geospatial information, information about a user who is allowed to use indoor geospatial information, security and charging information for utilizing indoor geospatial information, and information about a building and an indoor space based on which indoor geospatial information is configured.

The registration of the indoor geospatial information may include: when the user terminal searches for desired indoor geospatial information, receiving at least one of the following: authentication information of a user terminal for access to the desired indoor geospatial information; information about a type of indoor geospatial information to be searched; and a search condition regarding indoor geospatial information, and providing the user terminal with the access information regarding the indoor geospatial information found based on the received information.

Other features and aspects will be apparent from the following detailed description, the drawings, and the claims.

### BRIEF DESCRIPTION OF THE DRAWINGS

FIG. 1 is a diagram illustrating a configuration of an indoor geospatial information processing apparatus for indoor location-based services according to an exemplary embodiment.

FIG. 2 is a diagram illustrating in detail the indoor geospatial information processing apparatus of FIG. 1.

FIG. 3 is a flowchart illustrating the process of collecting and registering indoor geospatial information by the collector according to the exemplary embodiment.

FIG. 4 is a flowchart illustrating the process of search for and utilization of indoor geospatial information by a user terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

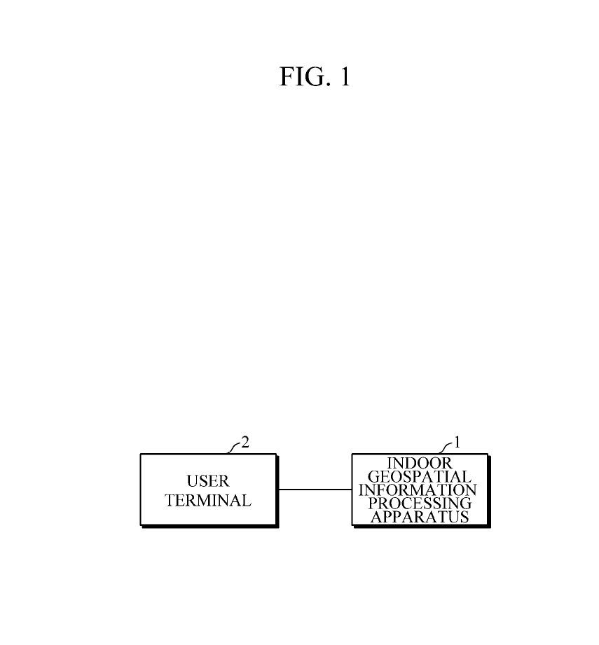

FIG. 1 is a diagram illustrating a configuration of an apparatus for processing indoor geospatial information for indoor location-based services according to an exemplary embodiment.

An apparatus 1 (hereinafter, will be referred to as an “indoor geospatial information processing apparatus 1”) for processing indoor geospatial information processes various types of indoor geospatial information of indoor spaces and provides the indoor geospatial information to a user terminal 2. Various location-based services (LBS) may be offered based on the indoor geospatial information. The indoor geospatial information processing apparatus 1 may be included in a device, such as a navigation device, which offers a location-based service, or the indoor geospatial information processing apparatus 1 may be separately provided. The indoor geospatial information processing apparatus 1 shares, searches for, and utilizes various forms of indoor geospatial information in order to provide the indoor location-based service.

Due to various features of indoor spaces, the indoor geospatial information cannot be configured or utilized by the same method as one used for outdoor geospatial information. For example, indoor areas in a specific indoor space are possessed and managed by different owners or managers, and hence, unlike the outdoor space, the indoor space cannot be formed by a single institution or subject. The owners or managers of the respective indoor areas may decide whether to disclose indoor map information, route information, points of interest (POI), and the like which are related to a service to be provided or features of the indoor space. The outdoor space can be seen as one space, the indoor space is, however, difficult to be seen as one space due to its variety of forms and locations, and hence it may need to specify a target, a range, and the like of pertinent indoor geospatial information using a different method from the one used for the outdoor geospatial information.

For the aforesaid reasons, various forms of indoor geospatial information that reflect the building structure and features of indoor space are shared and utilized. The various forms of indoor geospatial information may include indoor maps, indoor route information, indoor images, indoor POIs, indoor sensor information, etc. The indoor geospatial information processing apparatus 1 may register indoor geospatial information that the owners or managers of the indoor space desire to disclose or share with others. Then, an LBS user accesses the indoor geospatial information processing apparatus 1 through the user terminal 2 and searches for, shares and utilizes desired data.

In summary, the present disclosure relates to a technology for searching for, sharing, and utilizing various forms of indoor geospatial information that reflect both the building structure and features of indoor space. By using the aforementioned technology, the indoor geospatial information may be effectively shared and utilized, which cannot be accessed using a typical method for the outdoor space, for example, map information. Accordingly, it is possible to effectively offer indoor location-based services based on various types of indoor geospatial information. The indoor geospatial information may be classified according to the building structure and features of the indoor space and be associated with each other, and hence search for and sharing of the indoor geospatial information are possible.

Specified exemplary embodiments of the aforesaid description will be described below with reference to the accompanying drawings.

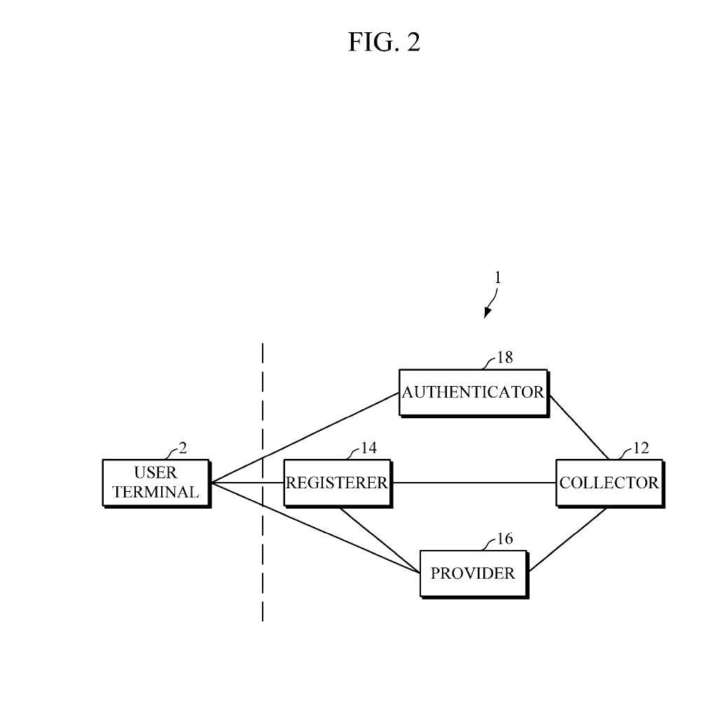

FIG. 2 is a diagram illustrating in detail the indoor geospatial information processing apparatus of FIG. 1.

Referring to FIG. 2, the indoor geospatial information processing apparatus 1 includes a collector 12, a registerer 14, a provider 16, and an authenticator 18.

The collector 12, the registerer 14, the provider 16, and the authenticator 18 are divided according to their functions, and may be configured as one integrated functional module or may be separated as individual functional modules. For example, the registerer 14 and the provider 16 may be installed in the same device. Each element may be formed as a server. For example, the collector 12 may be a collection server, the registerer 14 may be a registration server, the provider 16 may be a provision server, and the authenticator 18 may be an authentication server. The elements can communicate with one another through a wired/wireless network.

The term “indoor geospatial information” used herein is defined as below. The indoor geospatial information includes any information that can be described based on location information or spatial information related to a specific building or indoor space. The indoor geospatial information according to the exemplary embodiment includes an indoor map, POIs, an indoor space model, indoor positioning reference information, indoor condition information, indoor image information and other information.

More specifically, the indoor map and the POIs are visualized information to describe physical parts, such as doors, corridors, and walls, of the indoor space. They may be represented as 2-dimensional, 2.5-dimensional, or 3-dimensional vectors and image-based information.

The indoor space model is information to semantically describe the indoor space. The indoor space model includes information on space partitioning, route, usage, and the like of the indoor space. The indoor space model may include various thematic contents according to the views for description. For example, the various thematic contents may relate to space partitioning from the view of a sensor, a route technology from the view of a user who is moving, accessible information and security information of a specific indoor space, and the like.

The indoor positioning reference information refers to infrastructure information in various forms which is required for assisting the determination of a position (i.e., positioning) of a user terminal in the indoor space. For example, the indoor positioning reference information may be information about locations and properties of a wireless LAN AP, beacon, and/or RFID tag.

The indoor condition information dynamically represents the condition of the indoor space, such as a degree of congestion in a specific area of the indoor space. For example, said indoor condition information may refer to the number of people in a room.

Indoor image information represents the indoor space from various angles. Indoor image information may be used when visualizing the indoor space into an indoor map; when describing the specific condition as indoor condition information; or in a variety of services, as additional information that helps users in their decision-making. In addition, there may be a variety of extra information that include, as their attributes, locations and geospatial information related to the indoor space.

Unlike information regarding an outdoor space, the aforesaid indoor geospatial information may be packaged or grouped according to the building structure and features of the indoor space, and be referenced. One of differences between the indoor geospatial information and the outdoor geospatial information is that pieces of packaged or grouped indoor geospatial information are related with each other according to the building structure and features of the indoor space.

Hereinafter, elements for searching for, sharing, and utilizing the indoor geospatial information will be described in detail.

The user terminal 2 refers to any device, such as a smartphone, as long as the user uses it to be provided with a location-based service in an indoor space. The user terminal 2 according to an exemplary embodiment issues a request to the registerer 14 and receives access information regarding the indoor geospatial information through a communicator. Then, the user terminal 2 receives desired indoor geospatial information from the provider 16, using the access information regarding the indoor geospatial information. The user terminal 2 may be authenticated by the authenticator 18 for access to the indoor geospatial information.

The registerer 14 maintains and manages information as to which indoor geospatial information of a specific building or indoor space is registered for sharing. The registerer 14 receives the attribute information regarding the indoor geospatial information from the collector 12 and registers the received information. The attribute information includes information about the provider 16 that provides the indoor geospatial information, and thus the provider 16 is registered by the registerer 14. In addition, when the user terminal 2 searches for the indoor geospatial information, the registerer 14 provides access information regarding the found indoor geospatial information. The registerer 14 according to the exemplary embodiment may maintain the attribute information, such as a version of the registered indoor geospatial information, whereby specific registered information to be updated can be identified in the event of updating the indoor geospatial information. The attribute information to be registered by the registerer 14 regarding the indoor geospatial information will be described below with reference to Table 1.

The provider 16 stores the indoor geospatial information from the collector 12. The provider 16 provides the indoor geospatial information to the user terminal 2 that has the authentication information, in response to a request from the user terminal 2. The range and content of the indoor geospatial information to be provided may be confirmed from the access information that the user terminal 2 obtains from the registerer 14, regarding the indoor geospatial information.

The authenticator 18 maintains and manages the authentication information as to which indoor geospatial information can be used by a specific user terminal through a particular indoor location-based service. The authentication information refers to information used for determining whether it is allowed to provide designated indoor geospatial information to a given user terminal. Prior to the provision of the indoor location-based service, the authentication information may be specified according to a type of indoor location-based service and indoor geospatial information.

The collector 12 collects and extracts various forms of indoor geospatial information through various channels according to the building structure and features of the indoor space, and initially provides the collected indoor spatial information to be utilized for the indoor location-based service. The collector 12 according to the exemplary embodiment provides the indoor geospatial information to the provider 16, as well as provides the attribute information regarding the indoor geospatial information to the registerer 14, whereby the registerer 14 registers the indoor geospatial information.

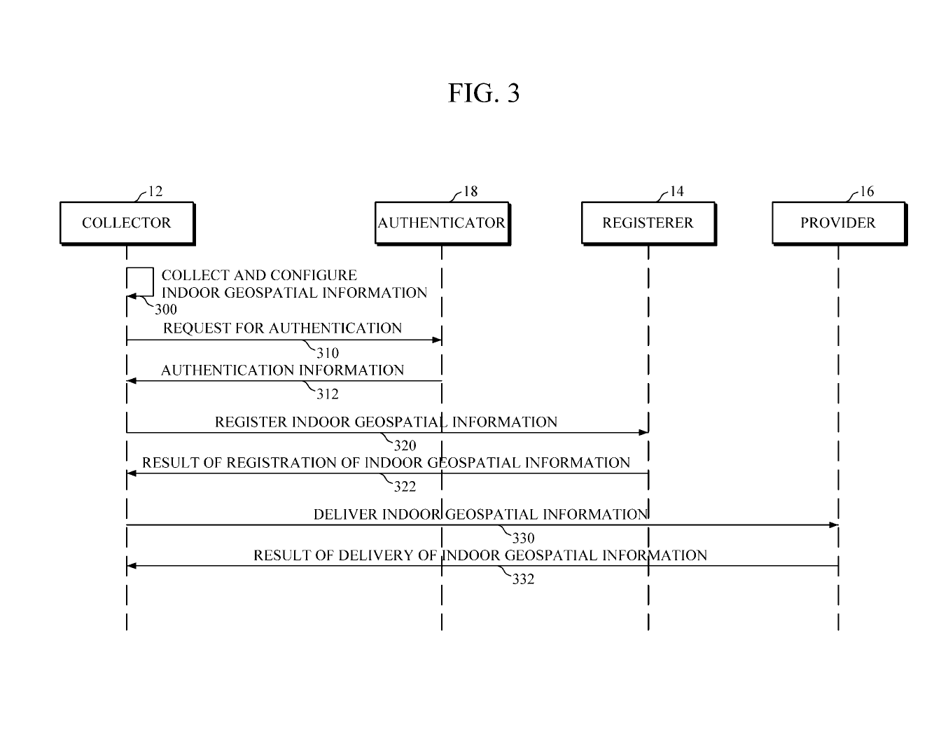

FIG. 3 is a flowchart illustrating the process of collecting and registering indoor geospatial information by the collector according to the exemplary embodiment.

Referring to FIG. 3, the collector 12 collects and configures the indoor geospatial information using various methods, as depicted by 300. Then, the collector 12 accesses and requests the authenticator 18 for authentication, as depicted by 310, and obtains authentication information, as depicted by 321. The authentication information includes information about an indoor location-based service accessible to indoor geospatial information or a type of indoor geospatial information service and a type of associated users. The authentication information specifies a user terminal that can access specific indoor geospatial information. It is possible to describe the authentication information in various ways according to features and type of service, and thus the present disclosure does not disclose specific methods for description of the authentication information.

Thereafter, the collector 12 registers attribute information in the registerer 14 regarding the indoor geospatial information to be shared, as depicted by 320, and receives the registration result, as depicted by 322. The information registered in the registerer 14 is not the indoor geospatial information itself, but the attribute information that specifies the indoor geospatial information. The attribute information will be described below with reference to Table 1. The registered indoor geospatial information can be searched by the user terminal. The collector 12 forwards the actual indoor geospatial information to the provider 16, and the provider 16 provides the received indoor geospatial information to the user terminal in response to its request.

The provider 16 is used for the reason of performance, not functionality. Storing the indoor geospatial information in the provider 16, rather than storing the indoor geospatial information in the registerer 14, is to reduce the load to the registerer 14 in case where multiple user terminals are simultaneously provided with an indoor location-based service. The indoor geospatial information may be, however, provided through the registerer 14 according to its attribute, such as features of the pertinent indoor location-based service, a size of the indoor geospatial information, or an update interval.

Table 1 shows attribute information regarding indoor geospatial information, which is registered by the collector 12 in the registerer 14. The information and attributes shown in Table 1 are specified by taking into consideration the building structure and features of indoor space.

TABLE 1

| Type of | | |
|---|---|---|
| information | Description | Specifics of attribute information |
| Information needed | Information to be provided | Type of indoor geospatial information |
| to be provided for | for enabling a user terminal | Set of search keywords for indoor geospatial |
| search for indoor | to search for indoor | information |
| geospatial | geospatial information to be | Information on a building related to indoor |
| information | registered | geospatial information |
| | | Coordinate system which indoor geospatial |
| | | information is based on |
| | | Geographical range related to indoor |
| | | geospatial information and reference |
| | | information therefor |
| | | Size and format of indoor geospatial |
| | | information |
| | | Version information of indoor geospatial |
| | | information |
| | | Validity period of registered indoor |
| | | geospatial information |
| | | Next update of registered indoor geospatial |
| | | information |
| | | Information about a building and an indoor |
| | | space based on which indoor geospatial |
| | | information is configured and obtained |
| Metadata regarding | Various types of attribute | <indoor map, POI> |
| indoor geospatial | information regarding indoor | Floor number of indoor map, POI, etc. |
| information | geospatial information to be | Numbers and sizes of indoor map and POI |
| | registered | Format and type of indoor map |
| | Metadata information is | <Indoor space model> |
| | attribute information that | Types of node and link that constitute a |
| | varies according to each type | route |
| | of indoor geospatial | Size of indoor space model |
| | information, whereas | <Indoor positioning reference information> |
| | information to be provided | Type of indoor positioning infrastructure |
| | for search is attribute | Attribute information, etc. of AP in |
| | information common to all | accordance with indoor positioning |
| | types of indoor geospatial | infrastructure |
| | information. | <Indoor condition information> |
| | | Type of indoor condition information |
| | | Attribute information regarding the unit of |
| | | numeric value of indoor condition |
| | | information |
| | | <Indoor image> |
| | | Type and resolution of indoor image |
| | | Location and camera angle at which indoor |
| | | image is obtained |
| | | <Other information> |
| | | Attribute varies according to type of specific |
| | | information |
| Information about | Information about an actual | Service access information, such as URL, |
| device that provides | provision device that | IP, port, etc. of an indoor geospatial |
| indoor geospatial | provides indoor geospatial | information provision device |
| information | information itself, which is | If necessary, an operating time of indoor |
| | to be registered | geospatial information provision device |
| Information about | Information about an entity | Name, address, and contact information of |
| provider of indoor | that configures and provides | institution that configures indoor geospatial |
| geospatial | indoor geospatial | information |
| information | information to be registered | Director and administrator relating to |
| | | configuration of indoor geospatial |
| | | information |
| | | Information related to configuration of |
| | | indoor geospatial information (e.g., |
| | | configuration interval) |
| Information about a | Information about a user | Authentication information regarding user |
| user allowed to use | who can access and utilize | terminal accessible to indoor geospatial |
| indoor geospatial | indoor geospatial | information to be registered (e.g., serial key |
| information (e.g., | information to be registered | or authentication code of a service) |
| level of | (A kind of authentication | |
| authentication) | information, whose form | |
| | may vary according to | |
| | features and type of relevant | |
| | service) | |
| Security and | Information about security | If necessary, security-related information |
| charging | and charging policies that | (e.g., security key) and charging information |
| information for | registered indoor geospatial | that a user terminal needs to know when |
| utilizing indoor | information follows | accessing and utilizing indoor geospatial |
| geospatial | | information |
| information | | |

In the attribute information defined in Table 1 relating to registration of indoor geospatial information, essential elements and optional elements thereof may be configured to vary depending on features of an indoor location-based service or the like. However, fundamentally, various forms of indoor geospatial information are cross-referenced, and registered and searched according to a variety of features of indoor space, for example, an address, a location, the floor number, a type of information, and the like. Such characteristics differentiate the indoor geospatial information-based service from an outdoor location information-based service.

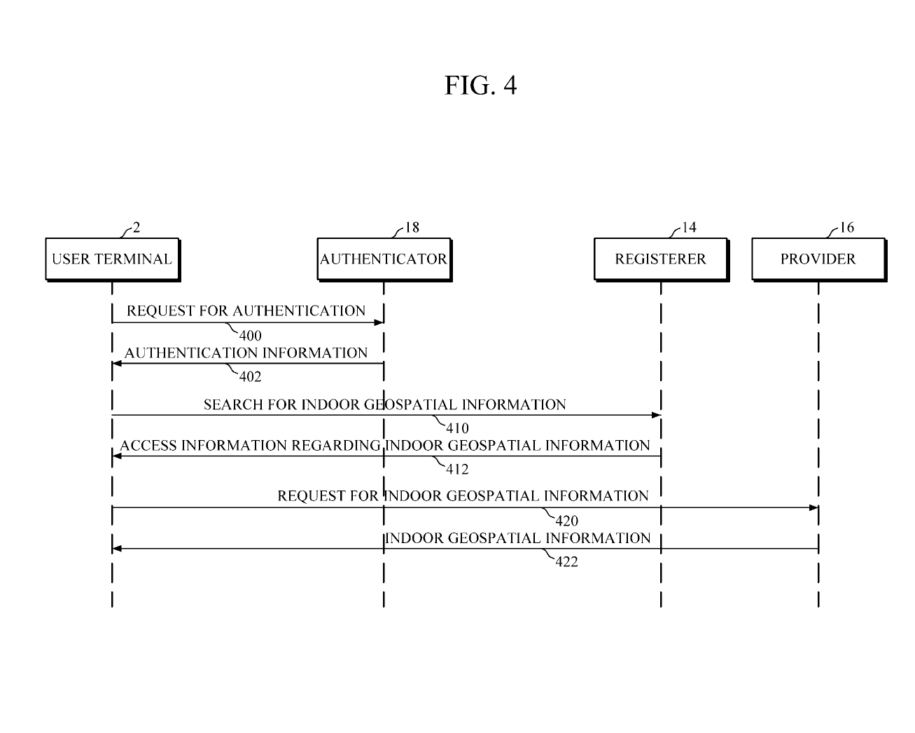

FIG. 4 is a flowchart illustrating the process of search for and utilization of indoor geospatial information by a user terminal according to an exemplary embodiment.

Referring to FIG. 4, to receive a desired indoor location-based service, a user terminal 2 issues a request for authentication to an authenticator 18, as depicted by 400, and then is authenticated, as depicted by 402. When the authentication is successful, the user terminal 2 accesses a registerer 14, delivers information as specified in Table 2, which will be described below, to the registerer 14, and then searches for desired indoor geospatial information, as depicted by 410. At this time, the information delivered from the user terminal 2 to the registerer 14 includes authentication information that specifies whether the access or search is appropriate, a type of indoor geospatial information to be found, and attributes (e.g., format, size, keywords, locations, etc.) of indoor geospatial information.

In response to receiving the user's request for search, the registerer 14 searches for particular indoor geospatial information that satisfies the user's requirements, from among the registered indoor geospatial information, and provides access information to the user terminal 2, wherein the access information indicates which provider 16 provides the found particular indoor geospatial information, as depicted by 412. In response to receiving the access information, the user terminal 2 accesses and requests the provider 16 for desired indoor geospatial information, as depicted by 420, and receives, in turn, the indoor geospatial information, as depicted by 422, thereby continuing to run an indoor location-based service.

Table 2 enumerates a list and descriptions of information to be delivered to the registerer 14, along with the search request, when various forms of indoor geospatial information are searched and utilized in the course of running an indoor location-based service by the user terminal 2. Like the information and attributes shown in Table 1, those shown in Table 2 reflect the building structure and features of indoor space.

TABLE 2

| Type of information | Description | Specifics of attribute information |
|---|---|---|
| Authentication | Information to confirm that | User ID, password |
| information for access | a user terminal is | Serial key for service to be provided |
| to indoor geospatial | authenticated for access to | If necessary, specific information used to access |
| information | desired indoor geospatial | indoor geospatial information (e.g., a type of user, |
| | information | gender, age, etc. of a user) |
| | | (such information may vary according to |
| | | authentication scheme provided by the indoor |
| | | location-based service) |
| Type (method) of | Search method for indoor | A type of indoor geospatial information to be |
| search for indoor | geospatial information to be | searched and corresponding attribute information |
| geospatial information | accessed and information | Search method for indoor geospatial information |
| | about a type of target indoor | (e.g., based on location, address, keyword, |
| | geospatial information | attribute information of a building, or the like.) |
| | | Information about institution (information |
| | | provider) that configures and provides indoor |
| | | geospatial information |
| Search condition for | Information about search | Search condition value according to search |
| indoor geospatial | conditions according to a | method for indoor geospatial information |
| information | type, features, and | <Location-based search> |
| | requirements of specific | Current location of user terminal and search range, |
| | indoor geospatial | etc. |
| | information | Search range from a given point, etc. |
| | | <Keyword-based search> |
| | | Building's name, search keyword, and POI, etc. |
| | | <Indoor space attribute-based search> |
| | | Specific POI, in the case of search of indoor |
| | | space (building) including said POI |
| | | Height, the number of stories, color or the like of a |
| | | building |
| | | <Information provider-based search> |
| | | Name, address, or the like of a person or |
| | | institution that configures and provides indoor |
| | | geospatial information |
| | | Search value according to a type of indoor |
| | | geospatial information to be searched |
| | | E.g., indoor map, a format of POI, value indicating |
| | | 2D or 3D, etc. |
| | | E.g., WiFi positioning reference information |

Like the information defined in Table 1, in the information defined in Table 2 relating to search for indoor geospatial information, essential elements and optional elements may be configured to vary depending on features of an indoor location-based service. However, various forms of indoor geospatial information are cross-referenced and searched according to a variety of features of indoor space, for example, an address, locations, the floor numbers, a type of information, and the like. Such characteristics differentiate the indoor geospatial information-based service from an outdoor location information-based service.

According to the exemplary embodiments as described above, it is possible to share, search and utilize information regarding an indoor space based on a variety of features of an indoor space. That is, various forms of information regarding the indoor space may be shared and registered according to application policies, and be searched based on the building structure and features of the indoor space. In the course of searching various forms of indoor geospatial information regarding the indoor space, the indoor geospatial information may be cross-referenced based on the feature information on the indoor space.

According to the exemplary embodiments, it is possible to efficiently share and utilize various forms of indoor geospatial information that cannot be accessed using a method of sharing map information regarding an outdoor space. It is also possible to efficiently provide an indoor location-based service based on various types of information about the indoor space.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing indoor geospatial information for an indoor location-based service, the apparatus comprising:
a registerer configured to classify and register indoor geospatial information according to conditions that include a structure of a building and features of indoor space, and provide a user terminal with access information regarding specific indoor geospatial information found by the user terminal; and
a provider configured to provide indoor geospatial information to the user terminal that has accessed the provider using the access information regarding the indoor geospatial information.

2. The apparatus of claim 1, wherein the indoor geospatial information includes at least one of the following: an indoor map, information about region of interest (ROI), an indoor space model, indoor positioning reference information, indoor condition information, and indoor image information, or information extracted therefrom.

3. The apparatus of claim 1, wherein the features of indoor space includes at least one of the following: an address, a location, a floor number, a type of indoor geospatial information.

4. The apparatus of claim 1, wherein the registerer registers attribute information regarding the indoor geospatial information by taking into consideration the conditions that include a structure of a building and features of indoor space.

5. The apparatus of claim 4, wherein the attribute information regarding the indoor geospatial information is cross-referenced, as well as registered as a package or a group into which the attribute information is classified according to the conditions that include a structure of a building and features of indoor space, so that the indoor geospatial information can be searched by the user terminal.

6. The apparatus of claim 4, wherein the attribute information regarding the indoor geospatial information includes at least one of the following: information needed to be provided for search for indoor geospatial information, metadata regarding indoor geospatial information, information about the provider that provides indoor geospatial information, information about an original provider of indoor geospatial information, information about a user who is allowed to use indoor geospatial information, security and charging information for utilizing indoor geospatial information, and information about a building and an indoor space based on which indoor geospatial information is configured.

7. The apparatus of claim 6, wherein the information needed to be provided for search for indoor geospatial information includes at least one of the following: a type of indoor geospatial information; a set of search keywords for indoor geospatial information; information about a building related to indoor geospatial information; a coordinate system which indoor geospatial information is based on; a geographical range related to indoor geospatial information and reference information therefor; a size and format of indoor geospatial information; version information of indoor geospatial information; validity period of registered indoor geospatial information; and next update of registered indoor geospatial information.

8. The apparatus of claim 1, wherein when the user terminal searches for desired indoor geospatial information, the registerer receives at least one of the following: authentication information of a user terminal for access to the desired indoor geospatial information; information about a type of indoor geospatial information to be searched; and a search condition regarding indoor geospatial information, and provides the user terminal with the access information regarding the indoor geospatial information found based on the received information.

9. The apparatus of claim 1, further comprising:
a collector configured to request the registerer to register attribute information regarding obtained indoor geospatial information, and deliver the obtained indoor geospatial information to the provider.

10. The apparatus of claim 1, further comprising:
an authenticator configured to authenticate a user terminal that is provided with an indoor location-based service.

11. A user terminal comprising:
a communicator configured to communicate with an apparatus for processing indoor geospatial information for an indoor location-based service,
wherein the communicator receives access information regarding specific indoor geospatial information found from the apparatus, accesses the apparatus using the access information, and receives the specific indoor geospatial information from the apparatus, wherein the apparatus classifies and registers a variety of indoor geospatial information according to conditions that include a structure of a building and features of indoor space and the specific indoor geospatial information is found from the registered indoor geospatial information.

12. The user terminal of claim 11, wherein the communicator requests the apparatus to search for attribute information regarding the indoor geospatial information which has been registered by taking into consideration the conditions that include a structure of a building and features of indoor space.

13. The user terminal of claim 12, wherein the attribute information regarding the indoor geospatial information is cross-referenced, as well as registered as a package or a group into which the attribute information is classified according to the conditions that include a structure of a building and features of indoor space, so that the indoor geospatial information can be searched by the user terminal.

14. The user terminal of claim 11, wherein the communicator is authenticated by making a request to the apparatus for processing indoor geospatial information.

15. A method for processing indoor geospatial information by an apparatus for processing indoor geospatial information, the method comprising:
classifying and registering a variety of indoor geospatial information according to conditions that include a structure of a building and features of indoor space;
providing a user terminal with access information regarding specific indoor geospatial information found by the user terminal; and
providing the specific indoor geospatial information to the user terminal that has accessed the apparatus using the access information.

16. The method of claim 15, wherein the indoor geospatial information includes at least one of the following: an indoor map, information about region of interest (ROI), an indoor space model, indoor positioning reference information, indoor condition information, and indoor image information, or information extracted therefrom.

17. The method of claim 15, wherein in the registration of the indoor geospatial information, attribute information regarding the indoor geospatial information is registered by taking into consideration the conditions that include a structure of a building and features of indoor space.

18. The method of claim 17, wherein the attribute information regarding the indoor geospatial information is cross-referenced, as well as registered as a package or a group into which the attribute information is classified according to the conditions that include a structure of a building and features of indoor space, so that the indoor geospatial information can be searched by the user terminal.

19. The method of claim 17, wherein the attribute information regarding the indoor geospatial information includes at least one of the following: information needed to be provided for search for indoor geospatial information, metadata regarding indoor geospatial information, information about a provider that provides indoor geospatial information, information about an original provider of indoor geospatial information, information about a user who is allowed to use indoor geospatial information, security and charging information for utilizing indoor geospatial information, and information about a building and an indoor space based on which indoor geospatial information is configured.

20. The method of claim 15, wherein the registration of the indoor geospatial information comprises: when the user terminal searches for desired indoor geospatial information, receiving at least one of the following: authentication information of a user terminal for access to the desired indoor geospatial information; information about a type of indoor geospatial information to be searched; and a search condition regarding indoor geospatial information, and providing the user terminal with the access information regarding the indoor geospatial information found based on the received information.
